(19) United States
(12) Patent Application Publication
(10) Pub. No.: US 2017/0341005 A1
(43) Pub. Date: Nov. 30, 2017

(54) FILTER CARTRIDGE

(71) Applicant: Carl Freudenberg KG, Weinheim (DE)

(72) Inventors: Karsten Schulz, Neckarbischofsheim (DE); Juergen Becker, Zeiskam (DE); Maik Sieh, Sandhausen (DE); Juergen Klaus, Hemsbach (DE)

(21) Appl. No.: 15/527,018

(22) PCT Filed: Dec. 14, 2015
(86) PCT No.: PCT/EP2015/079533

§ 371 Date: May 16, 2017

(30) Foreign Application Priority Data
Jan. 28, 2015 (EP) EP15152784.3

(51) Int. Cl. B01D 46/24; B01D 46/52

(52) U.S. Cl. CPC B01D 46/2411; B01D 46/521; B01D 2275/201; B01D 2275/206; B01D 2275/205

(57) ABSTRACT

A filter cartridge has a filter medium that is formed in such a way that it surrounds a central through-passage, wherein the central through-passage has a first opening and ends at a cartridge base, and wherein the filter medium extends between the first opening and the cartridge base and thereby forms an elongated filter body, which may influence the average ascent speed of air and bring about an optimum filtration operation, wherein the filter medium is rectangular or square-shaped at one end of the filter cartridge and is rounded at the other end.

### CROSS-REFERENCE TO RELATED APPLICATIONS

This application is a U.S. national stage application under 35 U.S.C. §371 of International Application No. PCT/EP2015/079533, filed on Dec. 14, 2015, and claims benefit to European Patent Application No. 15 152 784.3, filed on Jan. 28, 2015. The International Application was published in German on Aug. 4, 2016, as WO 2016/119967 A1 under PCT Article 21(2).

### FIELD

The invention relates to a filter cartridge according to the preamble of claim 1.

### BACKGROUND

The use of filter cartridges, especially circular filter cartridges, in dust extraction facilities and general industrial ventilation systems is already known. Against this background, rectangular or square adapters and flanges on cylindrical or oval filter cartridges have also become known.

A filter cartridge having a rectangular or square cross-section is disclosed in DE 102012017890 A1. This filter cartridge is preferably used in paint shops.

In paint shops, air loaded with wet paint particles is currently drawn through a dust chamber in which there is a bed of pulverized limestone. The pulverized limestone is intended to bind the wet paint particles.

Filter plates are attached to this dust chamber or to this bed. The air should be as clean as possible after passing through the filter plates.

The above-mentioned filter cartridges could also be used instead of filter plates, as these have a larger filter surface area. However, the filter cartridges would have to generate favorable flow conditions in the dust chamber so that as many paint particles as possible can be bound by the pulverized limestone.

### SUMMARY

An aspect of the invention provides a filter cartridge, comprising: a filter medium, formed such that the filter medium surrounds a central through-passage, wherein the central through-passage includes a first opening and ends at a cartridge base, wherein the filter medium extends between the first opening and the cartridge base and thereby forms an elongate filter body, wherein the filter medium is rectangular or square-shaped at one end of the filter cartridge and is rounded at the other end.

### BRIEF DESCRIPTION OF THE DRAWINGS

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 a perspective view of a filter cartridge.

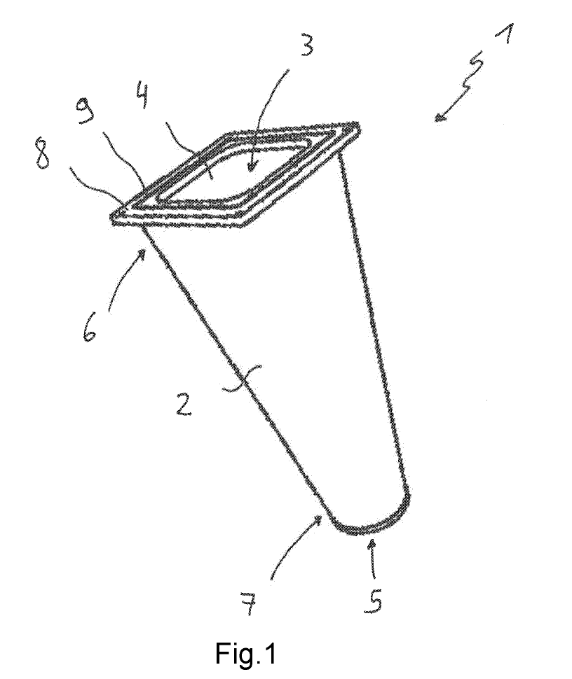

### DETAILED DESCRIPTION

An aspect of the invention is to provide a filter cartridge that influences the average ascent speed of air and brings about optimum filtration operation.

According to an aspect of the invention, it is recognized that the filter element according to the invention is able to make optimum use of space if a plurality of such filter elements are arranged next to one another. There is a reduction in the differential pressure in the system as a whole, since a larger air outlet surface area is formed on one plate.

Furthermore, due to the specific geometry of the filter cartridge and the arrangement in a housing on the dust-laden air side, this produces better flow conditions in the dust chamber for the process. This is similar to the formation of a fluidized bed. The dwell time for the lime powder to bind the paint is increased. In addition, pure air quality is improved due to the increased filter surface area.

According to the invention, this overcomes a prejudice on the part of specialists in the field, namely that angular filter cartridges tend to be disadvantageous in conventional dust extraction systems. The filter medium is specifically rectangular or square-shaped at one end of the filter cartridge and is rounded at the other end.

The flow rate per unit of filter surface area is reduced in an angular filter cartridge. This is due to the fact that the air outlet surface area in the top region is 18% larger in an angular filter cartridge than in a circular filter cartridge having an external diameter of 324 mm and an internal diameter of 215 mm. This results in a lower pressure differential with the same volume flow rate.

The elongate filter body could be conical in shape, or in other words taper in one direction. This makes it possible to achieve a particularly favorable flow profile in a fluidized bed.

The filter cartridge could be between 100 and 500 mm wide.

The filter cartridge could be between 10 mm and 2,500 mm high.

The height to width ratio of the filter cartridge could range from 1 to 1 to 5 to 1. Filter cartridges with this length-width ratio may advantageously be used instead of filter plates or tube elements arranged vertically or arranged horizontally and suspended.

The filter medium could be designed as a concertina with a pleated back running parallel to its longitudinal axis. As a result, the filter cartridge shows a high degree of stability with respect to compression in the longitudinal direction.

The concertina could be designed to be infinitely circumferential. This minimizes the number of cut edges and bonded joints.

The depth of the pleats in the concertina could be between 15 and 50 mm. This results in a uniform and homogeneous distribution of flow rates.

Support bands could be assigned to the concertina. Horizontally arranged support bands could preferably be assigned to the concertina. As a result, the distance between the pleats is permanently maintained.

The concertina could be molded in polyurethane on a lid. The concertina could be molded in polyurethane on the lid and/or base. This prevents leaks at the base and/or lid.

The filter medium could surround a support basket molded in polyurethane. This prevents the concertina from collapsing.

The support basket could be molded in polyurethane on the lid and/or base. As a result, the support basket is fixed permanently in position.

A circumferential seal could be applied to a lid. A preferably silicone-free seal could be applied to the lid and/or to the base. This thus ensures that the lid and/or base are sealed tightly against a flange.

The filter cartridge could be silicone-free.

The filter medium could be designed to have a plurality of layers, comprise a nanofiber layer, and be formed with antistatic properties. This means that very fine dirt particles can be filtered. The adhesion of fine dirt particles is reduced by equipping the filter cartridge with an antistatic (static electricity) finish.

The filter medium can be cleaned with compressed air.

One arrangement could comprise a filter housing having a dust chamber and at least one filter cartridge of the type described here, the filter cartridge projecting into the dust chamber.

The filter cartridge described here is suitable for use in a method in which a standard wet washing system based on water is replaced in wet painting processes by a dry system using filter elements.

To prevent the filter elements becoming clogged with paint, an inert filter aid, that is to say pulverized limestone, is used in excess and binds wet paint particles from an overspray in the air flow or on a filter surface. Filter plates and tube-type filter elements are used in the known systems, these being installed horizontally in the filter housing.

The filter cartridge described here creates better flow conditions in the dust chamber. This leads to the formation of a quasi-fluidized bed. This is associated with the geometry of the filter cartridge and with its arrangement on the dust-laden air side of the filter housing. The dwell time of the pulverized limestone for binding the paint is increased.

The filter cartridge described here makes it possible to achieve a uniform and homogeneous distribution of flow rates by forming equidistant filter cartridge intervals.

By designing the intervals appropriately, the region between the filter cartridges can be operated as a quasi-stationary fluidized bed. At the same time, more filter medium can be accommodated with the same distance between the pleats in a comparable construction area to the area defined by the diameter of a circular filter cartridge.

In addition, it is possible to design the top of the filter cartridge in an innovative form or according to the type of fastening.

A special design of the filter cartridge makes it possible to install one or more filter cartridges on the untreated gas side simply and safely with the aid of rapid-action fasteners. Fastening may take place using a bayonet catch or a quick-release catch. A multiple assembly is also conceivable of up to four filter cartridges in series by means of an assembly frame.

The filter element described here is preferably used for dry separation in a wet painting process. Furthermore, applications are also conceivable in industrial air filtration and in paint separation, particularly in the automotive industry.

Use in air filtration is specifically conceivable in situations in which particles and/or aerosols are separated in relatively large quantities in a pre-coating layer or a fluidized bed.

The single figure shows a filter cartridge 1 comprising a filter medium 2 that is formed in such a way that it surrounds a central through-passage 3, wherein the central through-passage 3 has a first opening 4 and ends at a closed cartridge base 5, and wherein the filter medium 2 extends between the first opening 4 and the cartridge base 5 and thereby forms an elongate filter body.

The filter medium 2 is rectangular or square-shaped at one end 6 of the filter cartridge 1 and is rounded at the other end 7.

The elongate filter body is conical in shape, or in other words tapers in one direction. The filter body tapers in the direction of the cartridge base 5.

The filter cartridge 1 is 100 to 500 mm wide and 1 mm to 2,500 mm high. The height to width ratio of the filter cartridge 1 ranges from 1 to 1 to 5 to 1.

The filter medium 2 is designed as a concertina with a pleated back running parallel to its longitudinal axis. The concertina is designed to be infinitely circumferential. The depth of the pleats in the concertina is 15 to 50 mm.

Support bands are assigned to the concertina. The concertina is molded in polyurethane on a lid. The filter medium 2 surrounds a support basket molded in polyurethane.

A circumferential seal 9 is applied to a lid 8.

The filter medium (2) is designed to have a plurality of layers, comprises a nanofiber layer and is formed with antistatic properties.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A filter cartridge, comprising:
a filter medium, formed such that the filter medium surrounds a central through-passage,
wherein the central through-passage includes a first opening and ends at a cartridge base,
wherein the filter medium extends between the first opening and the cartridge base and thereby forms an elongate filter body,
wherein the filter medium is rectangular or square-shaped at one end of the filter cartridge and is rounded at the other end.

2. The cartridge of claim 1, wherein the elongate filter body is conical.

3. The cartridge of claim 1, which in a range of from 100 to 500 mm wide.

4. The cartridge of claim 1, which is in a range of from 10 mm to 2,500 mm high.

5. The cartridge according to claim 1, having a height to width ratio in a range of from 1 to 1 to 5 to 1.

6. The cartridge of claim 1, wherein the filter medium is configured as a concertina with a pleated back running parallel to its longitudinal axis.

7. The cartridge of claim 6, wherein the concertina is configured to be infinitely circumferential.

8. The cartridge of claim 6, wherein pleats in the concertina are in a range of from 15 to 50 mm deep.

9. The cartridge of claim 6, further comprising:
support bands assigned to the concertina.

10. The cartridge of claim 6 wherein the concertina is molded in polyurethane on a lid.

11. The cartridge of claim 1, wherein the filter medium surrounds a support basket molded in polyurethane.

12. The cartridge of claim 1, further comprising:
a circumferential seal; and
a lid,
wherein the circumferential seal is applied to the lid.

13. The cartridge of claim 1, containing no silicone.

14. The cartridge of claim 1, wherein the filter medium is configured to include a plurality of layers including a nanofiber layer, and
wherein the filter medium has antistatic properties.

15. An arrangement, comprising:
a filter housing including a dust chamber; and
the cartridge of claim 1,
wherein the cartridge projects into the dust chamber.

16. The cartridge of claim 1, wherein the elongate filter body is tapered in one direction.
